(19) United States
(12) Patent Application Publication
(10) Pub. No.: US 2013/0102317 A1
(43) Pub. Date: Apr. 25, 2013

(54) ON-DEMAND DIRECTORY NUMBER CONTROL FUNCTION FOR A MOBILE DEVICE

(71) Applicants: Yixiang CHEN, Palo Alto, CA (US); Drew S. JOHNSON, San Jose, CA (US); Syed Zaeem HOSAIN, San Jose, CA (US); Mark E. CRATSENBURG, Orinda, CA (US); Kirk E. BREZEE, Richmond, CA (US); Dae Seong KIM, Campbell, CA (US)

(72) Inventors: Yixiang CHEN, Palo Alto, CA (US); Drew S. JOHNSON, San Jose, CA (US); Syed Zaeem HOSAIN, San Jose, CA (US); Mark E. CRATSENBURG, Orinda, CA (US); Kirk E. BREZEE, Richmond, CA (US); Dae Seong KIM, Campbell, CA (US)

(73) Assignee: AERIS COMMUNICATIONS, INC., San Jose, CA (US)

(21) Appl. No.: 13/424,276

(22) Filed: Mar. 19, 2012

Related U.S. Application Data
(60) Provisional application No. 61/550,020, filed on Oct. 21, 2011.

(51) Int. Cl. H04W 8/26; H04W 40/00

(52) U.S. Cl. 455/445; 455/458

(57) ABSTRACT

The present invention a method for assigning a temporary dialable number to a device having a non-dialable number so that the device may have the capability to be connected with, such as in being called back. In addition to the numerous benefits provides by the present invention, mobile device user in particular, are provided benefits to enable the health, safety and security of individuals who utilize emergency-based systems that do not have a dialable mobile device number (MDN) by the present invention.

### CROSS-REFERENCE TO RELATED APPLICATIONS

Under 35 USC 119(e), this application claims priority to U.S. provisional application Ser. No. 61/550,020, filed on Oct. 21, 2011.

### FIELD OF THE INVENTION

The present invention relates generally to mobile devices and more particularly to a method for associating a determinable on-demand number with one or more mobile devices.

### BACKGROUND OF THE INVENTION

A user's cellular phone is associated with a particular mobile device number (MDN). The MDN is typically assigned by the cellular phone carrier (i.e., network service provider) to the mobile device, the most familiar type of MDN being a telephone number for a cellular phone. For some cellular systems, the MDN may also act as username for logging into the user's account associated with the mobile device carrier's network, or similar. However, the assignment of an MDN to a mobile device enables that mobile device having an MDN to be identified and in communication with another device either on the same or different network. Each device also has a Mobile Identification Number (MIN) that is used to identify the associated service provider.

MDNs may be further categorized into two types of numbers, dialable and non-dialable. A dialable MDN is indicative of a number that may be used to complete a connection request. For instance, where a connection request is made for a dial-able MDN to a particular mobile device, the service network will accept the request and attempt to make the connection, when dialable. Conversely, where a connection request is made for a non-dial-able MDN, the service network will reject the request and the connection attempt will fail as the non-dialable MDN may not be called to. Consequently, a mobile device having a non-dialable MDN, though it is able to make connection requests (i.e., call) other devices and numbers, such a mobile device cannot be called back nor can such a device achieve a successful connection request from another mobile device.

Examples of device that may have non-dialable MDNs include but are not limited to telematic units (TSUs) having emergency notification capabilities typically situated in automobiles; child monitoring devices having limited periods of call-back during after-school hours; a warehouse tracking device that can only be called back when it is outside a designated area; a health monitoring device that can only be called back from doctor's office.

By further example, TSUs in cars can automatically dial an emergency number and establish a call with an emergency responder when an air bag in the car, for example, is deployed. TSUs, in these situations, are able to complete an emergency call out from a vehicle in distress and establish a connection with emergency services, but, such as in the event of inadvertent disconnections, a previously connected emergency service provider is unable to re-connect with the vehicle in distress once the connection is lost. This restriction and inability to connect with the originating device presents challenges which may involve life-threatening situations.

Accordingly, what is desired is a method to provide a mobile device having the limitation of a non-dialable MDN with the capability to be connected to by another device to enable a connection to be established with the mobile device, such as in a call-back situation.

As used herein the terms device, mobile device, third party system, smart phone, terminal, remote device, wireless asset, etc. are intended to be inclusive, interchangeable, and/or synonymous with one another and other similar communication-based equipment for purposes of the present invention though one will recognize that functionally each may have unique characteristics, functions and/or operations which may be specific to its individual capabilities and/or deployment.

As used herein the term dialable is intended to be inclusive of the definitions of being able and/or capable of being dialed; whereas the term non-dialable is intended to be inclusive of the definitions of not being able and/or not being capable of being dialed. Those of skill in the art will appreciate that terms such as dial-able and non-dialable are respectively interchangeable with the above definitions.

### SUMMARY OF THE INVENTION

The present invention fulfills these needs and has been developed in response to the present state of the art, and in particular, in response to the problems and needs in the art that have not yet been fully solved by currently available technologies.

One embodiment of the present invention includes a method for assigning a temporary dialable number to a device having a non-dialable number so that the device may have the capability to be connected with, such as in being called back.

Another embodiment of the present invention includes a method for assigning a dialable on-demand number to a device having an existing MDN, comprises: determining the MDN of the device is non-dialable; assigning a dialable MDN from a MDN number pool to the device; and mapping the assigned dialable MDN with the device and a MSC to enable service connection to the assigned dialable MDN.

A further embodiment of the present invention includes provides for a method for enabling a call back to a device having an MDN, comprises: determining an MDN of the device; comparing the received MDN of the device with a dataset associating previously assigned MDNs; retrieving an associated previously assigned MDN from the dataset; and using the previously assigned MDN as a dialable MDN for the device.

A further embodiment of the present invention provides for a computer program product stored on a computer usable medium, comprising: computer readable program means for causing a computer to control an execution of an application to perform a method for associating a dialable number to a device having an MDN, comprising, using temporary directory number control function (TDNCF) processing logic, determining the MDN of the device; assigning a dialable MDN from a MDN data pool; mapping the assigned dialable MDN to the device and a MSC to enable service connection to the assigned dialable MDN; and storing, using data storage means, the mapping of the assigned dialable MDN and the MSC with the existing MDN.

### BRIEF DESCRIPTION OF DRAWINGS

FIG. 1 depicts a Temporary Directory Number Control Function (TDNCF) mobile network reference diagram.

FIG. 2 illustrates a TDNCF as a routing proxy for device-originated call setup.

FIG. 3 illustrates a TDNCF as a standalone routing function for device-originated call setup.

FIG. 4 illustrates a TDNCF logic for device-originated call setup.

FIG. 5 illustrates a TDNCF for device-terminated call setup.

FIG. 6 illustrates a TDNCF logic for device-terminated call setup.

FIG. 7 illustrates a flow chart of TDNCF updating device registration prior to call setup.

FIG. 8 illustrates a flow chart of TDNCF logic for device registration update prior to call setup.

FIG. 9 illustrates a flow chart of TDNCF assigns permanent dialable MDN during device registration.

FIG. 10 illustrates a flow chart of TDNCF logic for permanent dialable MDN assignment during registration.

### DETAILED DESCRIPTION OF PREFERRED EMBODIMENTS

The present invention relates generally to mobile devices and more particularly to a method for associating a determinable on-demand number with one or more mobile devices. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

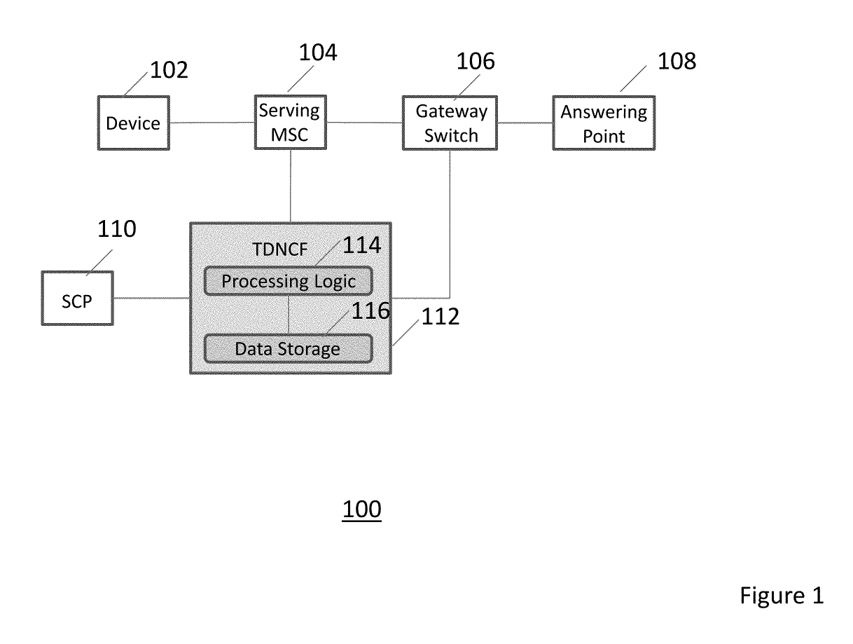

FIG. 1 depicts a Temporary Directory Number Control Function (TDNCF) mobile network reference diagram 100. The processing logic 114 and data storage 116 comprise a portion of the TDNCF 112. The signal control point (SCP) 110 is coupled to the TDNCF 112. The SCP, in a preferred embodiment, is a computer database that typically receives information request messages from a service network and returns information that is necessary for the completing connections for calls or services. As used herein, the SCP is used here to represent an external entity that controls the routing of the call. “Routing” in this sense is to determine the end address of the call. The end address can be a telephone number, an IP address, an email address, a URL, etc.

From FIG. 1, the device 102 is coupled to the serving mobile switching center (MSC) 104, which is coupled to the TDNCF 112. The MSC 104 is also coupled to the gateway switch 106 which is coupled to an answering point 108, as well as to the TDNCF 112.

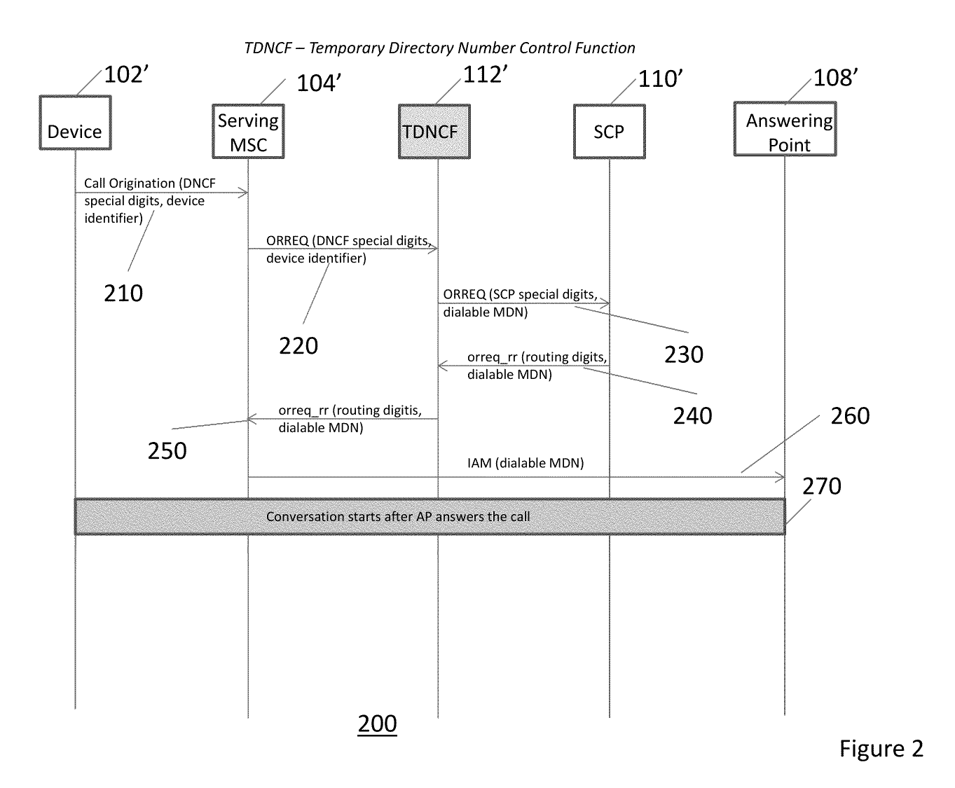

FIG. 2 illustrates a TDNCF as a routing proxy for device-originated call setup. The call origination (directory number call forwarding) DNCF special digits, a non-dialable MDN, originates from the device 102′ and is connected to the serving MCS 104′ at 210. The origination request (ORREQ) (DNCF special digits, non-dialable MDN) originates from the MSC 104′ and is connected to the TDNCF 112′ at 220. The ORREQ (SCP special digits, dialable MDN) originates from the TDNCF 112′ and is connected to the SCP 110′ at 230. Then, the ORREQ_RR (routing digits, dialable MDN) originates from the SCP 110′ and is connected to the TDNCF 112′ at 240. The ORREQ_RR originates from the TDNCF 112′ and is connected to the MSC 104′ at 250. Finally, the initial address message (IAM) (dialable MDN) originates from the MSC 104 and is connected to the answering point 108′ at 260. Thereafter, the conversation starts after the answering point answers the call, at 270.

MDN is a preferred embodiment, is an identifier to represent a device on a mobile network and may also exist in other forms such as identifiers including those for internet protocol (IP) addresses, email addresses, Uniform Resource Locators (URLs), etc.

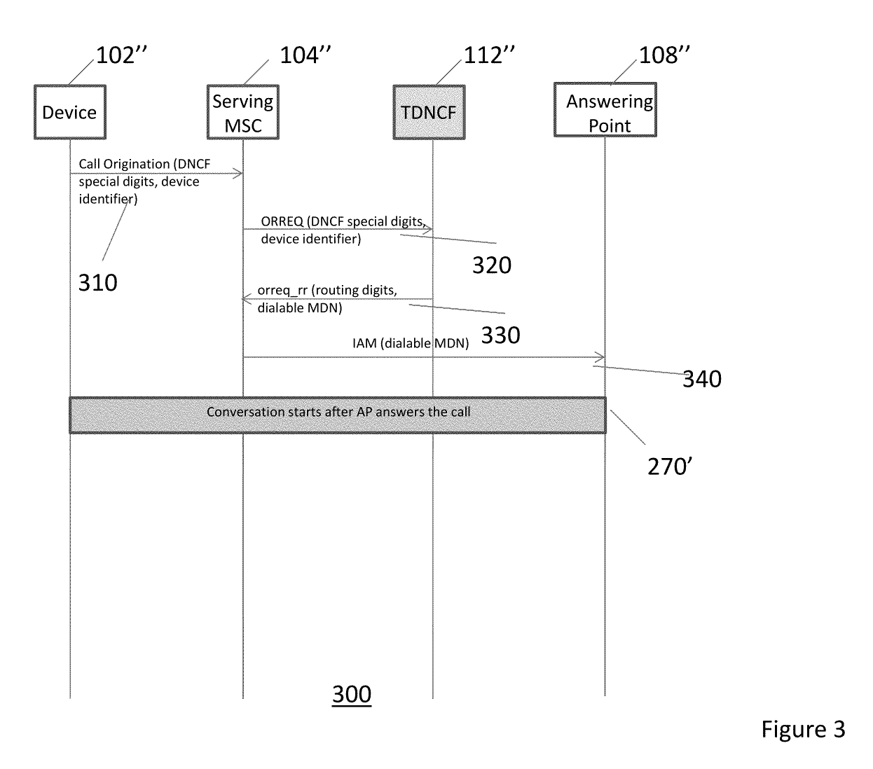

FIG. 3 illustrates a TDNCF as a standalone routing function for device-originated call setup. The call origination (DNCF special digits, non-dialable MDN) originates from the device 102″ and is connected to the MSC 104″ at 310. The ORREQ (DNCF special digits, non-dialable MDN) originates from the MSC 104″ and is connected to the TDNCF 112″ at 320. The ORREQ_RR (routing digits, dialable MDN) originates from the TDNCF 112″ and is connected to the MSC 104″ at 330. The IAM (dialable MDN) originates from the MSC 104″ and is connected to the answering point 108″ at 340. Thereafter the conversation starts after the answering point 108″ answers the call, at 270′.

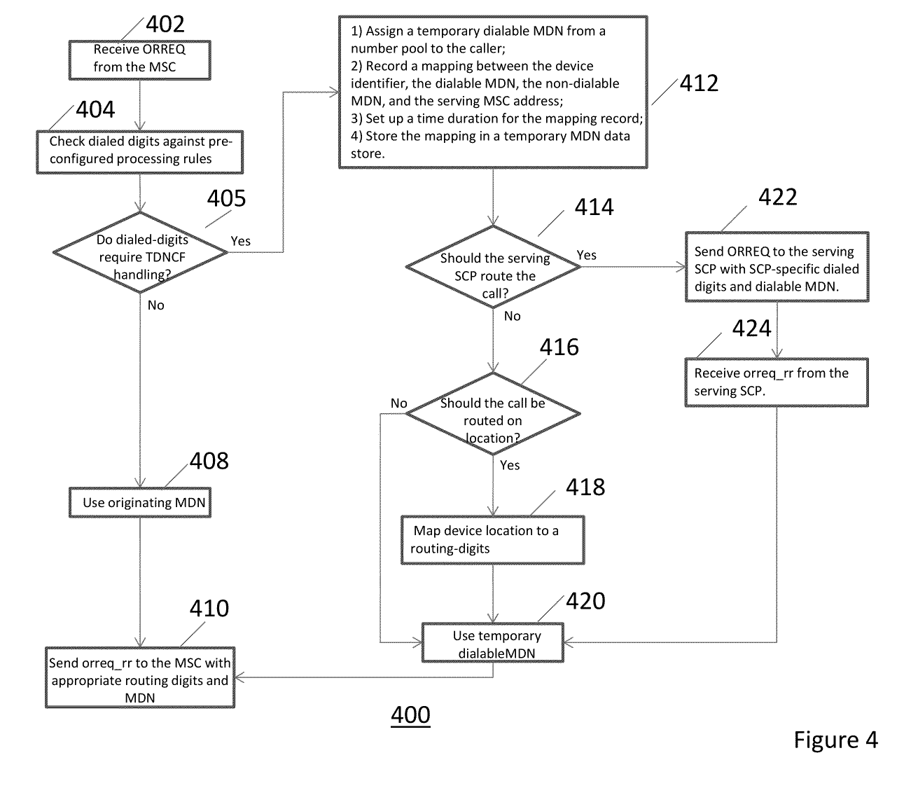

FIG. 4 illustrates a TDNCF Logic for device-originated call setup. First, the ORREQ is received from the MSC, at 402. Then, dialed digits are checked against pre-configured processing rules, at 404. A determination is made as to whether the dialed digits require TDNCF handling, at 406. In the even there is no need for TDNCH handling at 406, it is determined to use the originating MDN, at 408. Then an orreq_RR is sent to the MSC with appropriate routing digits and MDN, at 410.

However, from FIG. 4, if it is determined that the dialed-digits do require TDNCF handling, at 406, then at 412: (1) a temporary dialable MDN is assigned from a number pool to the caller; (2) a mapping is recorded between the device identifier, the dialable MDN, the non-dialable MDN, and the serving MSC address; (3) a time duration is determined for the mapping record; and (4) the mapping is stored in a temporary MDN data store. At 414 a determination is made as to whether the serving SCP should route the call.

If the determination at 414 is no, a further determination of whether the call should be routed in location is determined at 416. If the determination at 416 is no, a temporary dialable MDN is utilized at 420 and an ORREQ_RR is sent to the MSC with appropriate routing digits and MDN, at 410. If, however, the call is routed on location, at 416, then the map device location is routed to a routing-digits, at 418, with the use of a temporary dialable MDN, at 420 and an ORREQ_RR is sent to the MSC with appropriate routing digits and MDN, at 410.

If the determination at 414 is yes, then an orreq_RR is sent to the serving SCP with SCP-specific dialed digits and dialable MDN, at 422, whereafter the ORREQ_RR is received from the serving SCP, at 424. Thereafter, a temporary dialable MDN is used, at 420, and the orreq_RR is sent to the MSC with appropriate routing digits and MDN, at 410.

It will be appreciated by those skilled in the art that for FIGS. 4, 6, 8 and 10, diamond shapes are indicative of decision points in the process flow where decision outcomes may be achieved in relation to pre-configured processing rules and values. It will further be appreciated that such processing rules may be altered, modified and changed at any time to achieve further benefits and outcomes from the present invention.

In a preferred embodiment of the present invention, temporary MDNs may be assigned on-demand. Similarly, temporary MDNs may also have predetermined or specific time durations associated with their assignments so as to enable possible reuse or recycling of previously-assigned temporary MDNs.

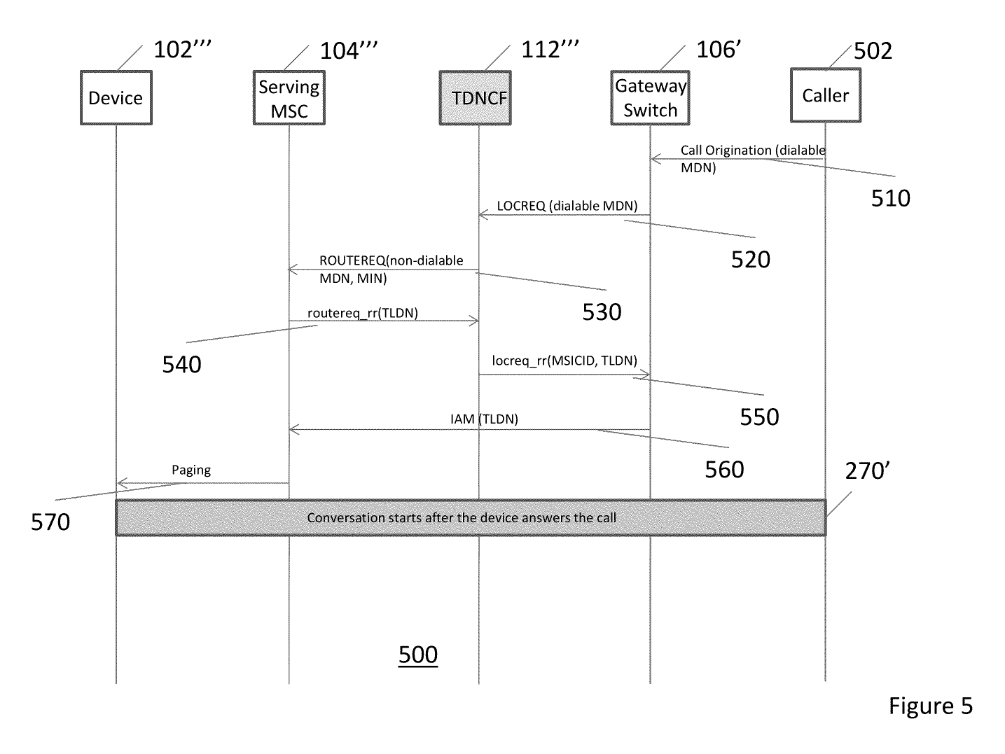

FIG. 5 illustrates a TDNCF for device-terminated call setup. The call origination (dialable MDN) originates from the caller 502 and is connected to the gateway switch 106′ at 510. The location request (LOCREQ) (dialable MDN) originates from the gateway switch 106′ and is connected to the TDNCF 112′″ at 520. The router request ROUTEREQ (non-dialable MDN, MIN, mobile identification number) originates from the TDNCF 112′″ and connects to the MSC 104′″ at 530. The routereq_rr (TLDN) originates from the MSC 104′″ and is connected to the TDNCF 112′″ at 540. The locreq_rr (MSICID, TLDN) originates from the TDNCF 112′″ and is connected to the gateway switch 106′ at 550. The IAM temporary location directory number (TLDN) originates from the gateway switch 106′ and is connected to the MSC 104′″ at 560. The paging originates from the MSC 104′″ and terminates at the device 102′″ at 570. The conversation starts after the device answers the call, via step 270′.

By example, in a preferred implementation, the scenario of FIG. 5 may occur where the call is dropped and the Answering Point in previous Figures calls back to the device. In such a scenario, the Answering Point becomes “Caller” in this particular case.

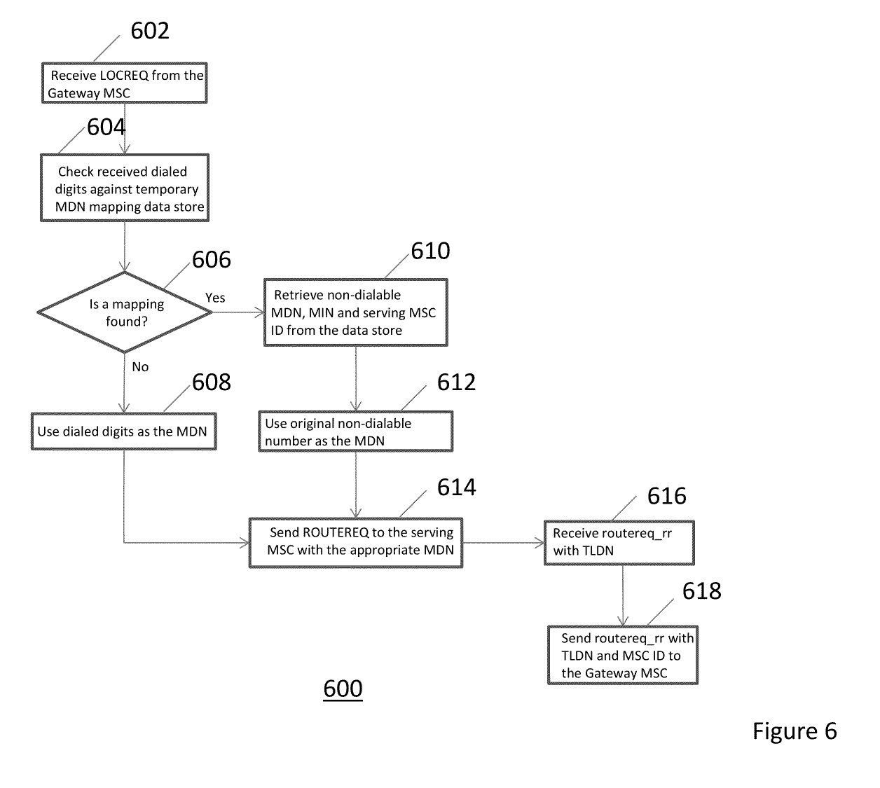

FIG. 6 illustrates a TDNCF Logic for device-terminated call setup. First, a LOCREQ is received from the gateway MSC, at 602. Then received dialed digits are checked against temporary MDN mapping data store, at 604. If a mapping is not found, then dialed digits are used as the MDN, at 608. Thereafter, routereq is sent to the serving MSC with the appropriate MDN, at 614. When the routereq_rr is received with TLDN, at 616, a routereq_rr with TLDN is sent along with an MSC ID to the gateway MSN, at 618. Returning to step 606, if a mapping is found, at 606, then a non-dialable MDN is retrieved, MIN and serving MSC ID from the data store, at 610. An original non-dialable number is then used as the MDN, at 612. A routereq is sent to the serving MSC with the appropriate MDN, at 614. A routereq_rr with TLDN is received, at 616. A routereq_rr with TLDN and MSC ID is sent to the gateway MSC, at 618.

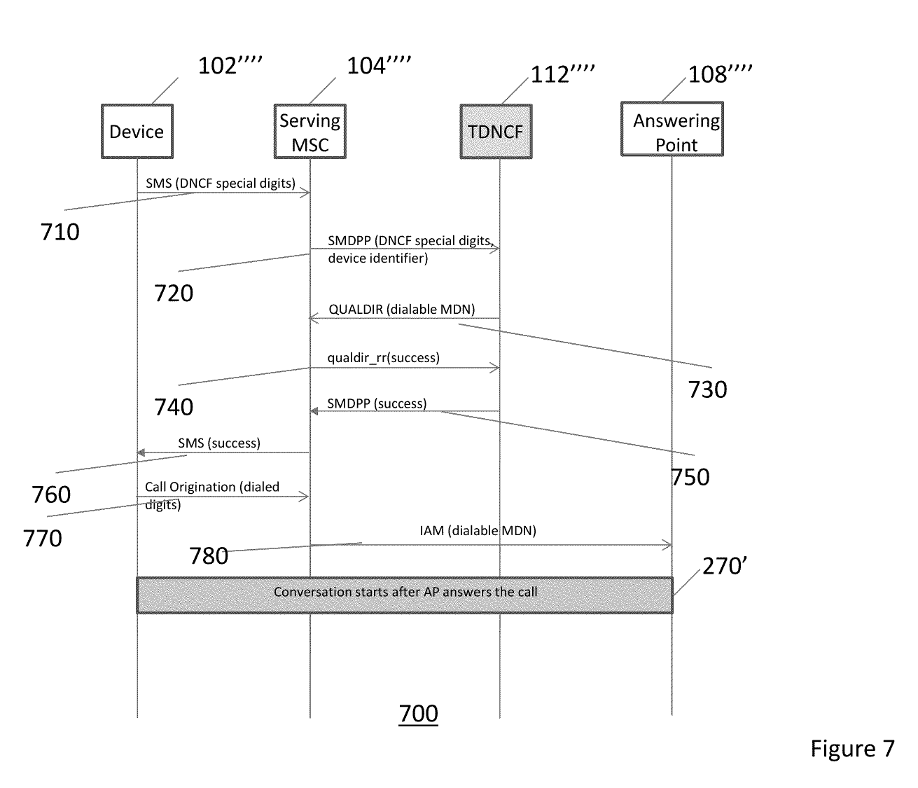

FIG. 7 illustrates a flow cart of TDNCF updating a device registration prior to call setup.

From FIG. 7, the SMS (DNCF special digits) originates from the device 102″″ and is connected to the serving MSC 104″″ at 710. In another embodiment, a special dialing pattern can originate from the device such as combination of keys on the keypad such as *480. The SMDPP (DNCF special digits non-dialable MDN) originates from the Serving MSC 104″″ and is connected to the TDNCF 112″″ at 720. In another embodiment, a feature request FEAREQ can originate from the Serving MSC. The QUALDIR (dialable MDN) originates from the TDNCF 112″″ and is connected to the Serving MSC 104″″ at 730. The qualdir_rr (success) originates from the Serving MSC 104″″ and is connected to the TDNCF 112″″ at 740. The SMDPP (success) originates from the 112″″ and is connected to the Serving MSC 104″″ at 750. The SMS (success) originates from the Serving MSC 104″″ and is connected to the device 102″″ at 760. The Call Origination (dialed digits) originates from the device 102″″ and is connected to the Serving MSC 104″″ at 770. The IAM (dialable MDN) originates from the Serving MSC 104″″ and is connected to the Answering Point 108″″ at 780. Thereafter, the conversation starts after the Answering Point answers the call, at 202′.

In a preferred embodiment, the TDNCF dynamically updates the device registration record in the network with a dialable number before the device makes a mobile-originated call. In a further preferred embodiment, the TDNCF uses QUALDIR (Qualification Directive) to update the device registration in the MSC, where this particular registration record is only used for call setup such that the device is provisioned with a non-dialable number. It will be appreciated by those skilled in the art that when the device receives a SMS from the TDNCF acknowledging the success of the registration changes, the device will then make a call as it normally would.

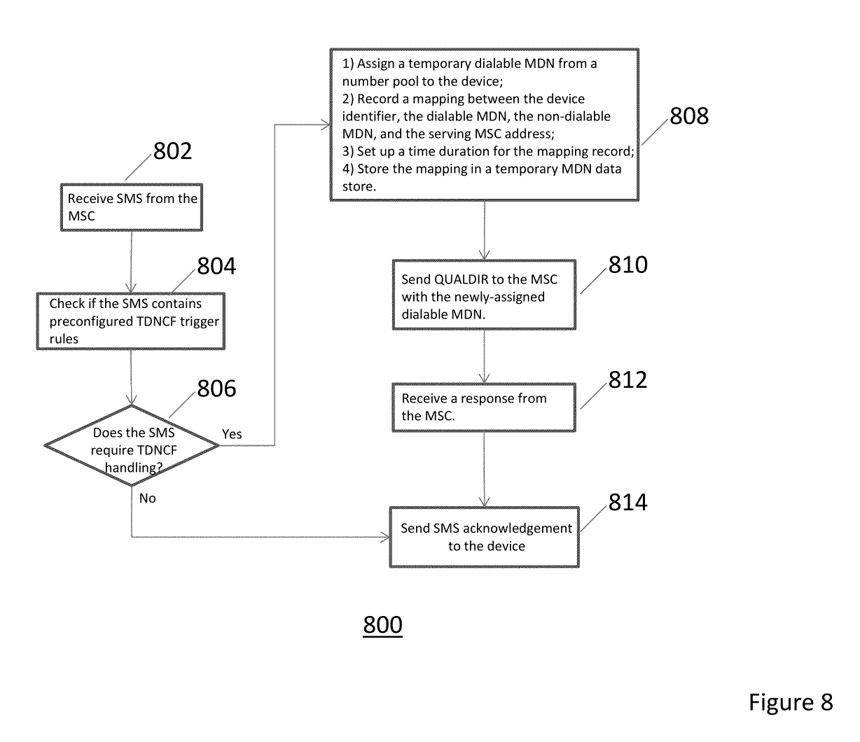

FIG. 8 illustrates a flow chart of TDNCF logic for device registration update prior to call setup. First, receive SMS from the MSC, at 802. Then, the SMS is checked as to containing preconfigured TDNCF trigger rules, at 804. If the SMS does not requires TDNCF handling, at 806, then a SMS acknowledgement is sent to the device, at 814.

If the SMS does requires TDNCF handling, at 806, then the following occurs in a preferred embodiment at 808: (1) a temporary dialable MDN is assigned from a number pool to the device; (2) a mapping record between the device identifier, the dialable MDN, the non-dialable MDN, and the serving MSC address is made; (3) a time duration for the mapping record is determined; and (4) the mapping is stored in a temporary MDN data store. Following the processing of 808, a QUALDIR is sent to the MSC with the newly-assigned dialable MDN, at 810. Then, a response is received from the MSC, at 812. Then a SMS acknowledgement is sent to the device, at 814.

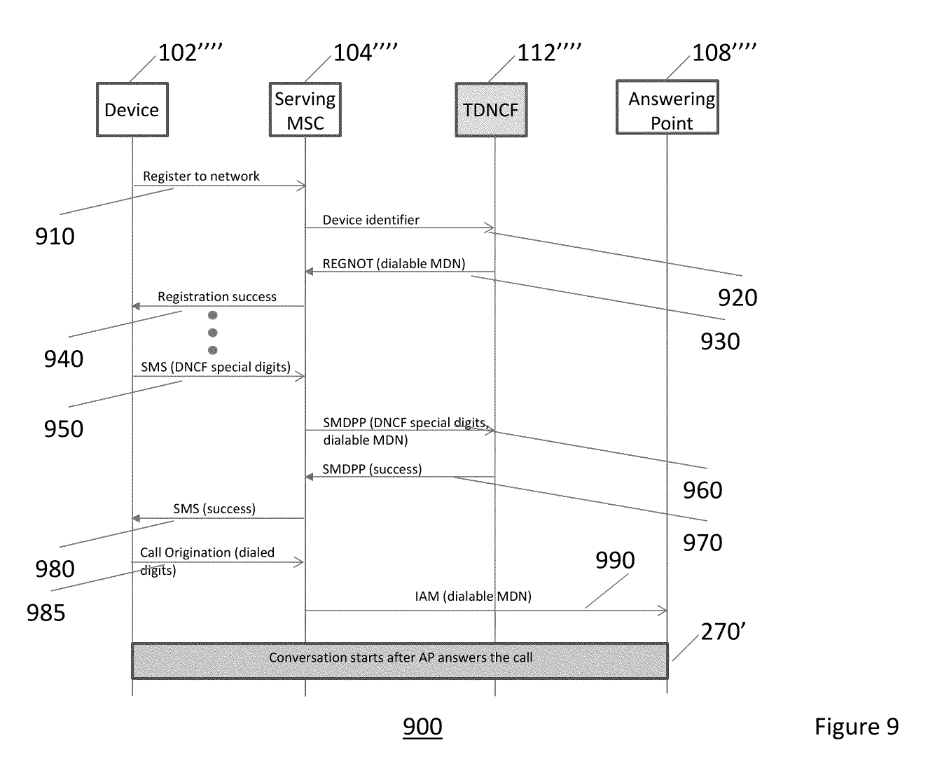

FIG. 9 illustrates a flow chart of TDNCF assigns permanent dial-able MDN during device registration. The register originates from the device 102″″ and is connected to the Serving MSC 104″″ at 910. The REGNOT (non-dialable MDN) originates from the Serving MSC 104″″ and is connected to the TDNCF 112″″ at 920. The REGNOT (dialable MDN) originates from the TDNCF 112″″ and is connected to the Serving MSC 104″″ at 930. The registration success originates from the Serving MSC 104″″ and is connected to the device 102″″ at 940. The SMS (DNCF special digits) originates from the device 102″″ and is connected to the Serving MSC 104″″ at 950. In another embodiment, a special dialing pattern can originate from the device such as combination of keys on the keypad such as *480. The SMDPP (DNCF special digits dialable MDN) originates at the Serving MSC 104″″ and is connected to the TDNCF 112″″ at 960. In another embodiment, a feature request FEAREQ can originate from the Serving MSC. The SMDPP (success) originates from the TDNCF 112″″ and is connected to the Serving MSC 104″″ at 970. The SMS (success) originates from the Serving MSC 104″″ and is connected to the device 102″″ at 980. The Call Origination (dialed digits) originates from the device 102″″ and is connected to the Serving MSC 104″″ at 985. The IAM (dialable MDN) originates from the Serving MSC 104″″ and is connected to the Answering Point 108″″ at 990. Thereafter, the conversation starts after the Answering Point answers the call, at 270′.

In one or more preferred alternative embodiments, the present invention enables the TDNCF to assign a permanent dialable MDN to the device when the device registers to the network. In operation, the device would register with the network when it is powered on before it can use the network for SMS or call origination; the TDNCF may normally block all calls to the dialable MDN; the present invention therefore provides for that when the device needs to dial a number that allows callback, the device sends a trigger to TDNCF before making the call. The trigger may be an SMS or any other message that the device can send to TDNCF through the MSC. Such a trigger, when used with the present invention, will make TDNCF temporarily unblock calls to the dial-able MDN for a configurable period of time.

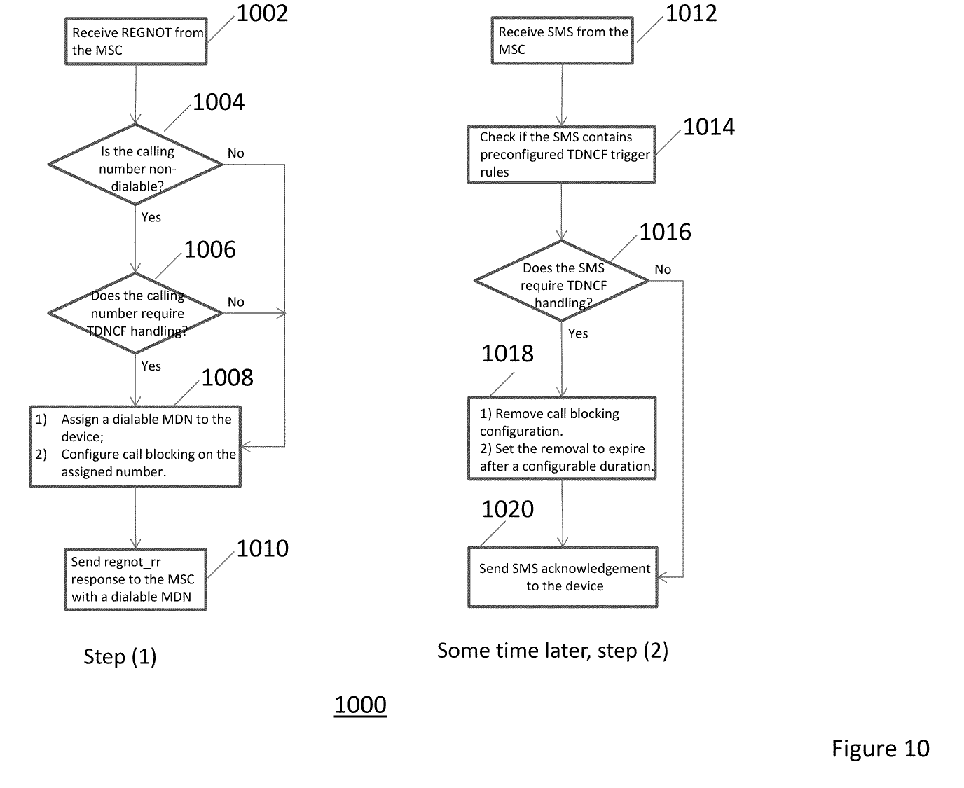

FIG. 10 illustrates a TDNCF logic for permanent dialable MDN assignment during registration. From FIG. 10, there are two steps to the process, step 1 including processes 1002-1010 and step 2 including processes 1012-1020.

First, the REGNOT is received from the MSC, at 1002. If the calling number is determined to be dialable at 1004, then (1) dialable MDN is assigned to the device; and (2) call blocking is configured on the assigned number at 1008.

If, however, the calling number is determined to be non-dialable at 1004, then a determination as to whether the calling number requires TDNCF handling is made at 1006. If it is determined that the calling number requires TDNCF handling or that the calling number does not require TDNCF, then at 1008: (1) a dialable MDN is assigned to the device; and (2) call blocking is configured on the assigned number. Thereafter, a regnot_rr response is sent to the MSC with a dialable MDN, at 1010. This concludes step 1; step 2 then follows at a later period.

For step 2, a SMS is received from the MSC, at 1012. Next, the SMS is checked for containing preconfigured TDNCF trigger rules, at 1014. If the SMS does not require TDNCF handling at 1016, then a SMS acknowledgement is sent to the device at 1020. If the SMS does require TDNCF handling at 1016, then at 1018: (1) call blocking configuration is removed; and (2) the removal is set to expire after a configurable duration. Thereafter, a SMS acknowledgement is sent to the device, at 1020.

Under the present invention, in one or more embodiments the assignment of a dialable number on-demand for devices is provided for. While there are many benefits for the present invention, one particular advantage of this invention is that a small number of dialable numbers may be used for a large number of non-dialable devices as not all of the devices will concurrently use the numbers at the same time. Therefore, the present invention is immediately demonstrative of superior resource utilization. Further the present invention not only allows non-dialable mobile devices to be improved over present safety standards but also creates new opportunities for on-demand callback of non-dialable mobile devices.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. Many other embodiments of the present invention are also envisioned.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

What is claimed is:

1. A method for assigning a dialable on-demand number to a device having an existing mobile device number (MDN), comprising:
determining the MDN of the device is non-dialable; assigning a dialable MDN from a MDN number pool to the device; and
mapping the assigned dialable MDN with the device and a mobile switching center (MSC) to enable service connection to the assigned dialable MDN.

2. The method of claim 1, wherein the existing MDN is non-dialable.

3. The method of claim 2, further comprising setting a predetermined expiration time for the assigned dialable MDN.

4. The method of claim 3, wherein mapping further comprising mapping the assigned dialable MDN and the MSC with the existing MDN.

5. The method of claim 4, further comprising storing the mapping of the assigned dialable MDN and the MSC with the existing MDN.

6. The method of claim 5, further comprising providing appropriate routing information associated with the assigned dialable MDN to the MSC.

7. The method of claim 6, wherein the assigned dialable MDN is temporary as the expiration period is of a predetermined value.

8. The method of claim 6, further comprising placing a call to the assigned dialable MDN and establishing a service connection.

9. A method for enabling a call back to a device having an existing mobile device number (MDN), comprising:
determining an MDN of the device; comparing the received MDN of the device with a dataset associating previously assigned MDNs; and
retrieving an associated previously assigned MDN from the dataset; and using the previously assigned MDN as a dialable MDN for the device.

10. The method of claim 9, further comprising associating the previously assigned MDN from the dataset with the device and a mobile switching center (MSC).

11. The method of claim 10, wherein the existing MDN is non-dialable.

12. The method of claim 10, wherein retrieving an associated previously assigned MDN from the dataset further comprises retrieving a non-dialable MDN, a Mobile Identification Number (MIN) and MSC identity from the dataset.

13. The method of claim 10, further comprising providing appropriate routing information associated with the previously assigned MDN to the MSC to enable routine and a service connection.

14. The method of claim 13, wherein the previously assigned MDN has an expiration period.

15. The method of claim 13, further comprising placing a call to the previously assigned MDN and establishing a service connection.

16. The method of claim 15, wherein the device is a telematic service unit (TSU).

17. The method of claim 15, wherein the device is a health monitoring device.

18. A computer program product stored on a computer usable medium, comprising:
computer readable program means for causing a computer to control an execution of an application to perform a method for associating a dialable number to a device having an existing mobile device number (MDN), comprising executing;
using temporary directory number control function (TDNCF) processing logic;
determining the MDN of the device; assigning a dialable MDN from a MDN data pool;
mapping the assigned dialable MDN to the device and a mobile switching center (MSC) to enable service connection to the assigned dialable MDN; and
storing, using data storage means, the mapping of the assigned dialable MDN and the MSC with the existing MDN.

19. The program product of claim 18, further comprising the TDNCF logic establishing a predetermined expiration time for the assigned dialable MDN.

20. The program product of claim 19, further comprising the TDNCF providing routing information to establishing a service connection for the device.
